(19) United States
(12) Patent Application Publication
(10) Pub. No.: US 2005/0273531 A1
(43) Pub. Date: Dec. 8, 2005

(54) Display device including two communication ports and display system including same

(76) Inventors: Thomas A. Domitrovich, Aliquippa, PA (US); Vincent Ferri, Pittsburgh, PA (US); Timothy F. Thompson, Pittsburgh, PA (US)

Correspondence Address: Martin J. Moran, Esquire;Eaton Electrical, Inc., Technology & Quality Center, 170 Industry Drive, RIDC Park West, Pittsburgh, PA, 15275-1032, US

(21) Appl. No.: 10/862,308

(22) Filed: Jun. 7, 2004

(51) Int. Cl. G06F 13/12

(52) U.S. Cl. 710/62

(57) ABSTRACT

A display device includes a first communication port communicating with a host device, a second communication port communicating with plural slave devices, and a processor circuit including a processor, an interface to the first and second ports and a display. A communication routine cooperates with the processor circuit. The routine includes a first mode of operation that receives a first message from the host device to the first port and repeats the same from the second port to a first slave device, and receives a second message from the first slave device to the second port and repeats the same from the second port to the host device. A second mode interrupts the first mode, sends third messages from the second port to a second slave device, receives fourth messages including information from the second slave device to the second port, and outputs the information to the display.

### BACKGROUND OF THE INVENTION

1. Field of the Invention

This invention pertains generally to display devices and, more particularly, to display devices including plural communication ports. The invention also relates to display systems including a display device.

2. Background Information

The INCOM (INdustrial COMmunications) Network provides two-way communication between an INCOM network master and a variety of products such as, for example, electrical interrupting devices, circuit breakers, digital meters, motor overload relays, monitoring units and a wide range of industrial products. Control and monitoring is carried out over a network consisting of dedicated twisted pair wires. Preferably, a semi-custom integrated circuit provides a simple, low cost interface to the network. For example, a Sure Chip Plus™ microcontroller enables the electrical interrupting device to communicate with the INCOM network. This integrated circuit provides various network functions such as, for example, carrier generation and detection, data modulation/demodulation, address decoding, and generation and checking of a 5-bit cyclic redundant BCH error code.

An INCOM communication module, which may be otherwise known as a PONI “Product Operated Network Interface,” may act as an interface device between a remote personal computer PC and the electrical meter, protector or control communicating device that does not have a built-in INCOM transceiver.

The INCOM network employs a simple two-wire asynchronous communication line, which is daisy chained to the several devices. A master device digitally addresses each of the slave devices in a master/slave relationship for the purpose of gathering the data generated by the individual units for central processing. An INCOM network can have one master and up to 1000 slaves. The INCOM communications protocol is based on 33-bit message packets. A typical INCOM network transaction consists of one or more 33-bit message packets transmitted by the master, and one or more 33-bit message packets transmitted by a slave in response.

Examples of the INCOM network and protocol are disclosed in U.S. Pat. Nos. 4,644,547; 4,644,566; 4,653,073; 5,315,531; 5,548,523; 5,627,716; 5,815,364; and 6,055,145, which are incorporated by reference herein.

Any suitable computer or programmable device (e.g., with an RS-232C communications port; PC XT/AT bus) may function as an INCOM network master. An RS-232C based INCOM network master employs a gateway device such as the MINT (Master INCOM Network Translator). The gateway device converts the 10 byte ASCII encoded hexadecimal RS-232C messages to or from 33-bit binary messages used on the INCOM local area network.

An IBM XT or AT compatible personal computer alternatively employs the CONI (Computer Operated Network Interface) for interfacing to the INCOM network. The CONI employs a direct PC-bus interface, which provides a more efficient network interface than that of the MINT.

There are two basic types of INCOM messages: control messages and data messages. The messages are 33 bits in length and are sent with the Least Significant Bit (LSB) first. An INCOM chip, for example, generates a number of the bits including the Start bits, Stop bit and BCH error detection code. The format for an INCOM-control message is shown in Table 1.

TABLE 1

| Bit Number(s) | Mnemonic | Definition |
|---|---|---|
| 1-0 | STR | Start Bits = 11 |
| 2 | C/D | Control Bit = 1 for Control Messages |
| 6-3 | INST | Instruction Field |
| 10-7 | COMM | Command Field |
| 22-11 | ADDRESS | Address of Product (Slave Device) |
| 26-23 | SCOMM | SubCommand Field |
| 31-27 | BCH | BCH error detection field |
| 32 | STP | Stop Bit = 0 |

The format for an INCOM-Data message is shown in Table 2.

TABLE 2

| Bit Number(s) | Mnemonic | Definition |
|---|---|---|
| 1-0 | STR | Start Bits = 11 |
| 2 | C/D | Control Bit = 0 for Data Messages |
| 10-3 | BYTE0 | 8-bit data field (Bit 3 = b0) |
| 18-11 | BYTE1 | 8-bit data field (Bit 11 = b0) |
| 26-19 | BYTE2 | 8-bit data field (Bit 18 = b0) |
| 31-27 | BCH | BCH error detection field |
| 32 | STP | Stop Bit = 0 |

There are two types of INCOM slave devices (products): a stand-alone slave, and an expanded mode slave. The stand-alone slave is a device on an INCOM network that can control one digital output and monitor up to two status (digital) inputs. An example of a stand-alone slave device is an addressable relay marketed by Eaton Electrical, Inc. of Pittsburgh, Pa. A stand-alone slave device uses INCOM control messages exclusively for communications.

The expanded mode slave is a device on an INCOM network that can send and/or receive data values over the INCOM network including, for example, analog and digital I/O data, configuration or setpoint information, and trip data. Examples of such devices include IQ Data Plus II Line Metering Systems, Digitrip RMS 700 and 800 Trip Units, and IQ 1000 and IQ 500 Motor Protection Systems, all marketed by Eaton Electrical, Inc. An expanded mode slave device uses INCOM control messages and INCOM data messages for communications.

There are seven examples in which an expanded mode slave product, in response to a command from the master, may send a return-command message to the master. These include: (1) Acknowledge (ACK) Reply; (2) Negative Acknowledge (NACK) Reply; (3) Product Buffer Not Yet Available; (4) Sub-network Product Not Responding; (5) Checksum Error; (6) Downloaded Value Out of Range; and (7) Product Not in a State That Allows the Requested Action.

Some INCOM commands require the product to transmit an acknowledge (ACK) message. The positive acknowledge indicates that the product accepted the present command or the data transmission was completed successfully. The format of the ACK message, ignoring the Start bits, Stop bit and BCH error detection code, includes: (1) C/D=1; (2) INST=3; (3) COMM=1; (4) ADDRESS=address of slave (some products may employ address 000H or FFFH; other products can assume any address in the 12 bit address space); and (5) SCOMM=0. The product will transmit a negative acknowledge (NACK), rather than an ACK, in response to certain conditions. The negative acknowledge indicates that the product has not accepted the COMM and SCOMM command request. The format of the NACK message, ignoring the Start bits, Stop bit and BCH error detection code, includes: (1) C/D=1; (2) INST=3; (3) COMM=1; (4) ADDRESS=address of slave (some products may employ address 000H or FFFH; other products can assume any address in the 12 bit address space); and (5) SCOMM=1.

For example, some conditions for which a product will respond with a NACK include: (1) the product received an INCOM control message that it does not recognize (e.g., an INCOM control message with INST=3, and COMM and SCOMM values that it does not support); and (2) the PONI received an INCOM control message that it cannot process due to a communications failure between the PONI and the product. Products only respond to INCOM messages containing a good BCH value.

Examples of standard master-to-slave commands for the Integrated Monitoring, Protection, And Control Communication (IMPACC) protocol are shown below, in Table 3. All of these commands employ C/D=1 and, thus, only the INST, COMM, and SCOMM specifications are provided. The words transmit and receive in the command definitions are with respect to the product. If the message is a transmit command, then the result will be the transmission of data from the product to the master. On the other hand, a receive command that is transmitted from the master to the product will be followed by data transmissions from the master, which are to be received by the product. Table 3 shows six classes of standard master-to-expanded mode slave commands.

TABLE 3

| Command | INST | COMM | SCOMM |
|---|---|---|---|
| Standard slave-buffer transmissions | 3 | 0 | 0-F |
| Standard system management | 3 | A | 3-7 |
| buffer transmissions | | | |
| Product specific slave-buffer transmissions | 3 | C | 8-F |
| Standard slave actions | 3 | D | 0,1,3 |
| Standard master-buffer transmissions | 3 | D | 8-F |
| Product specific master-buffer transmissions | 3 | F | 8-F |
| Broadcast Command | D | 0-F | 0-F |

A few examples of these communications data buffers are discussed, below. A standard data buffer includes a specification for the formatting of analog data in engineering units. For example, the IMPACC 24-Bit Floating Point Number Format permits the IMPACC family to include a number of products that send similar analog parameters (e.g., currents, voltages). Each parameter is sent as a single data transmission with the three bytes defined as follows: (1) BYTE0 is the low-order byte of 16-bit magnitude; (2) BYTE1 is the high-order byte of 16-bit magnitude; and (3) BYTE2 is the scale byte, wherein the BYTE2 bit definitions (b7-b0) are as follows: (a) for bit b7: 0 indicates that the value in BYTE0 and BYTE1 is a 16-bit unsigned integer, and 1 indicates that the value in BYTE0 and BYTE1 is a 16-bit signed integer; (b) for bit b6: 0 indicates that the data is invalid, and 1 indicates that the data is valid; (c) for bit b5: 0 indicates a multiplier as a power of 2, and 1 indicates a multiplier as a power of 10, and (d) the bits b4-b0 represent the multiplier's exponent in 5-bit signed integer form. This allows a magnitude of multiplier to range from 2⁻¹⁶ to 2⁺¹⁵ (for b5=0), or 10⁻¹⁶ to 10⁺¹⁵ (for b5=1).

Table 4 shows the Standard Expanded Mode Slave-Buffer Transmissions (for COMM=0 and SCOMM=0−F).

TABLE 4

| INST | COMM | SCOMM | Command Definition |
|---|---|---|---|
| 3 | 0 | 0 | Transmit Fast-Status. |
| 3 | 0 | 3 | Transmit All Standard Buffers |
| 3 | 0 | 5 | Transmit Current Buffer |
| 3 | 0 | 6 | Transmit Line-to-Line Voltage Buffer |
| 3 | 0 | 7 | Transmit Line-to-Neutral Voltage Buffer |
| 3 | 0 | 8 | Transmit Power Buffer(1) |
| 3 | 0 | 9 | Transmit Power Buffer(2) |
| 3 | 0 | A | Transmit Energy Buffer |
| 3 | 0 | B | Transmit Saved Energy Buffer |
| 3 | 0 | C | Transmit Saved Reactive Energy Buffer |
| 3 | 0 | F | Receive Expanded Transmit Buffer |
| | | | Number |

Table 5 shows the Buffer Numbers for the Receive Expanded Transmit Buffer Number Command (for COMM=0 and SCOMM=F).

TABLE 5
Buffer

| No. | Buffer Description |
|---|---|
| N = 1 | Transmit Temperature Buffer |
| N = 2 | Transmit Demand Currents Buffer |
| N = 3 | Transmit Current Buffer |
| N = 4 | Transmit Line-Line Voltage Buffer |
| N = 5 | Transmit Line-Neutral Voltage Buffer |
| N = 6 | Transmit Power Buffer |
| N = 7 | Transmit Per-Phase Power Buffer |
| N = 8 | Transmit System Energy Buffer |
| N = 9 | Transmit THD Buffer |
| N = 10 | Transmit Demand Current Buffer (w/ time stamp) |
| N = 11 | Transmit Per-Phase Demand Current Buffer (w/ time stamp) |
| N = 12 | Transmit Demand Power Buffer (w/ time stamp) |
| N = 13 | Transmit Min/Max Current Buffer (w/ time stamp) |
| N = 14 | Transmit Min/Max L-L Voltage Buffer (w/ time stamp) |
| N = 15 | Transmit Min/Max L-N Voltage Buffer (w/ time stamp) |
| N = 16 | Transmit Min/Max PF-Displacement Buffer (w/ time stamp) |
| N = 17 | Transmit Min/Max PF-Apparent Buffer (w/ time stamp) |
| N = 18 | Transmit Min/Max Power/Frequency Buffer (w/ time stamp) |
| N = 19 | Transmit Min/Max Current % THD Buffer (w/ time stamp) |
| N = 20 | Transmit Min/Max Voltage % THD Buffer (w/ time stamp) |
| N = 21 | Transmit Crest Factor Buffer |
| N = 22 | Transmit Min/Max per-phase real power (w/ time stamp) |
| N = 23 | Transmit Min/Max per-phase reactive power (w/ time stamp) |
| N = 24 | Transmit Min/Max per-phase VA (w/ time stamp) |
| N = 25 | Transmit Min/Max Currents Buffer (w/o time stamp) |
| N = 26 | Transmit Demand Currents Buffer (w/o time stamp) |
| N = 27 | Transmit Demand Power Buffer (w/o time stamp) |
| N = 28 | Transmit Min/Max Voltage Buffer (w/o time stamp) |
| N = 29 | Transmit Min/Max Power/Frequency/PF Buffer (w/o time stp.) |
| N = 30 | Transmit Min/Max Current % THD Buffer (w/o time stamp) |
| N = 31 | Transmit Min/Max Voltage % THD Buffer (w/o time stamp) |
| N = 32 | Transmit Min/Max Current THD Magnitude Buf. (w/ time stp.) |
| N = 33 | Transmit Min/Max Voltage THD Magnitude Buf. (w/ time stp.) |
| N = 34 | Transmit Whole Load Center Energy Buffer |

The Transmit All Standard Buffers command definition (3 0 3 of Table 4) covers the standard buffers as defined by INST=3, COMM=0, and SCOMM=5 through A.

The Transmit Current Buffer (3 0 5 of Table 4) response consists of four data messages, each containing an IMPACC 24-bit Floating Point Number, with the current units being expressed in amperes. The four messages respectively include: (1) phase current IA; (2) phase current IB; (3) phase current IC; and (4) current IX, which is usually ground current, although for some products there is no ground current and the current IX may be either a fourth pole current or a neutral current.

The Transmit Line-to-Line Voltage Buffer (3 0 6 of Table 4) response consists of three data messages, each containing an IMPACC 24-bit Floating Point number, with the voltage units being expressed in volts. The three messages respectively include: (1) line-to-line voltage VAB; (2) line-to-line voltage VBC; and (3) line-to-line voltage VCA.

The Transmit Line-to-Neutral Voltage Buffer (3 0 7 of Table 4) response consists of three data messages, each containing an IMPACC 24-bit Floating Point number, with voltage units being expressed in volts. The three messages respectively include: (1) line-to-neutral voltage VAN; (2) line-to-neutral voltage VBN; and (3) line-to-neutral voltage VCN.

The Transmit Expanded Buffer (3 0 F of Table 4) command allows for the use of additional standard responses beyond those covered by INST=3, COMM=0, and SCOMM=3 to E. The Expanded Buffer command consists of the following communications sequence. First, the Master sends the Slave a Transmit Expanded Buffer Number command. Second, the Slave responds with an ACK. Next, the Master sends the Slave a single data message containing the expanded buffer number. Finally, the Slave sends the requested buffer as a series of data messages. The first byte, BYTE0, of the first data message specifies the total number data messages (e.g., up to about 43) to be sent. The expanded buffer number, N, is sent as a 24 bit binary number.

For example, for the Currents Buffer (N=3), there are seven data messages including: (1) Number of additional messages (BYTE0=6); (2) Phase A current; (3) Phase B current; (4) Phase C current; (5) Ground current; (6) Neutral current; and (7) Average phase current.

Although it is known to request, receive and display information from a plurality of slave devices at a host device, there exists a need for user interaction with a different display and for locally or manually requested display information.

Accordingly, there is room for improvement in display devices and in display systems including a display device.

### SUMMARY OF THE INVENTION

These needs and others are met by the present invention, which provides a local or user display, separate from a host device, that allows a user to view information from one or more slave devices on a second communication network with minimal disruption of host device/slave device communications originating from a first communication network.

In accordance with one aspect of the invention, a display device comprises: a first communication port adapted to communicate with a host device; a second communication port adapted to communicate with a plurality of slave devices; a processor circuit including a processor, an interface to the first and second communication ports, an output device and an input device; and a communication routine cooperating with the processor circuit, the communication routine including a first mode of operation and a second mode of operation, the first mode of operation adapted to receive a first message from the host device to the first communication port and to repeat the first message from the second communication port to a first one of the slave devices, and adapted to receive a second message from the first one of the slave devices to the second communication port and to repeat the second message from the second communication port to the host device, the second mode of operation adapted to interrupt the first mode of operation, to send at least one third message from the second communication port to a second one of the slave devices, to receive at least one fourth message including information from the second one of the slave devices to the second communication port, and to output the information to the output device.

The slave devices may include a plurality of types. The communication routine may further be adapted to send a request from the second communication port to each of the slave devices, and to receive a response from each of the slave devices to the second communication port, the response defining one of the types for a corresponding one of the slave devices.

Each of the slave devices may include an address associated with the second communication port. The request may include the address of a corresponding one of the slave devices. The response may include the type of the corresponding one of the slave devices. The processor circuit may further include a memory storing the address and the type of the corresponding one of the slave devices.

The communication routine may further be adapted to periodically send the at least one third message, to periodically receive the at least one fourth message, and to periodically output the information to the output device.

The communication routine may further be adapted to determine if no message has been received from the host device to the first communication port for a predetermined time before disabling the first mode of operation and enabling the second mode of operation.

The communication routine may further be adapted to determine if a predetermined message has been received from the host device to the first communication port before disabling the first mode of operation and enabling the second mode of operation.

The communication routine may further be adapted to disable the second mode of operation and enable the first mode of operation after one of the at least one fourth message has been received from the second one of the slave devices to the second communication port.

The communication routine may further be adapted to disable the second mode of operation and enable the first mode of operation after no message has been received from the second one of the slave devices to the second communication port after a predetermined time.

The at least one third message may include a plurality of third messages. The at least one fourth message may include a plurality of fourth messages. The communication routine may further be adapted to disable the first mode of operation and enable the second mode of operation before sending one of the third messages from the second communication port to the second one of the slave devices and to disable the second mode of operation and enable the first mode of operation after one of the fourth messages has been received from the second one of the slave devices to the second communication port.

The communication routine may further be adapted to output the information for all of the fourth messages to the output device after all of the fourth messages are received from the second one of the slave devices to the second communication port.

As another aspect of the invention, a display system comprises: a host device; a first communication network; a plurality of slave devices; a second communication network; and a display device comprising: a first communication port communicating with the host device over the first communication network, a second communication port communicating with the slave devices over the second communication network, a processor circuit including a processor, an interface to the first and second communication ports, an output device and an input device, and a communication routine cooperating with the processor circuit, the communication routine including a first mode of operation and a second mode of operation, the first mode of operation receiving a first message from the host device to the first communication port and repeating the first message from the second communication port to a first one of the slave devices, and receiving a second message from the first one of the slave devices to the second communication port and repeating the second message from the second communication port to the host device, the second mode of operation interrupting the first mode of operation, sending at least one third message from the second communication port to a second one of the slave devices, receiving at least one fourth message including information from the second one of the slave devices to the second communication port, and outputting the information to the output device.

### BRIEF DESCRIPTION OF THE DRAWINGS

A full understanding of the invention can be gained from the following description of the preferred embodiments when read in conjunction with the accompanying drawings in which:

FIG. 1 is a block diagram in schematic form of a display device and a display system in accordance with the present invention.

FIG. 2 is a front vertical elevation view of the display and keyboard of the display device of FIG. 1.

FIGS. 3A-3E are representations of different menus of the display of FIG. 2.

FIGS. 4A-4D are flowcharts of routines executed by the processor of FIG. 1.

### DESCRIPTION OF THE PREFERRED EMBODIMENTS

The present invention is described in association with INCOM communication networks, although the invention is applicable to a wide range of communication ports, networks and systems.

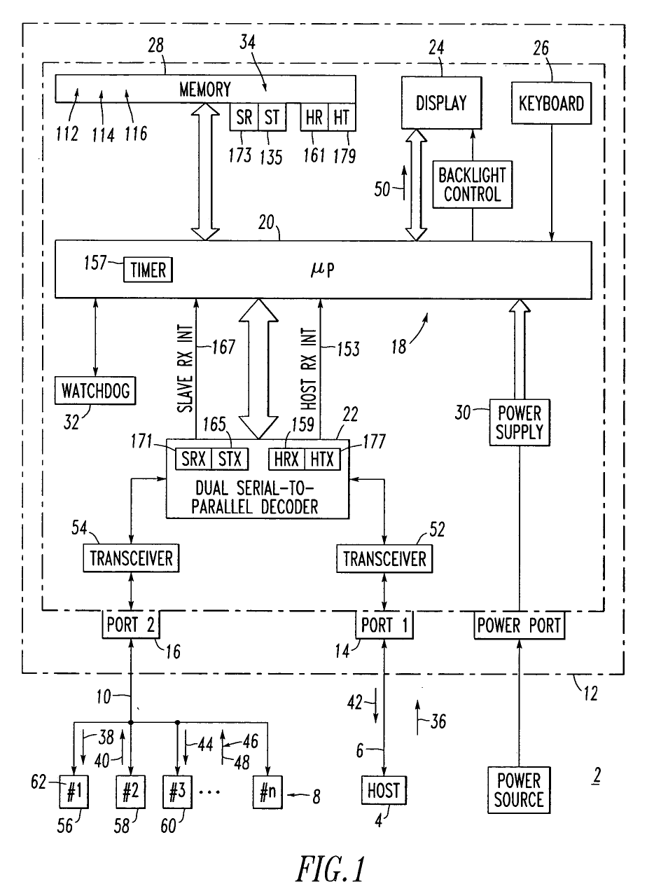

Referring to FIG. 1, a display system 2 includes a host device 4, a first communication network 6, a plurality of slave devices 8 (e.g., device #1, device #2, device #3, device #n), a second communication network 10, and a display device 12. The display device 12 includes a first communication port 14 communicating with the host device 4 over the first communication network 6, a second communication port 16 communicating with the slave devices 8 over the second communication network 10, and a processor circuit 18 including a suitable processor (e.g., a μP) 20, an interface 22 to the first and second communication ports 14,16, a suitable output device 24 and a suitable input device 26.

The processor circuit 18 also includes a memory 28 and a power supply 30. Preferably, the processor circuit 18 further includes a watchdog timer circuit 32, which “wakes up” the processor 20 if it detects an extended period of processor inactivity.

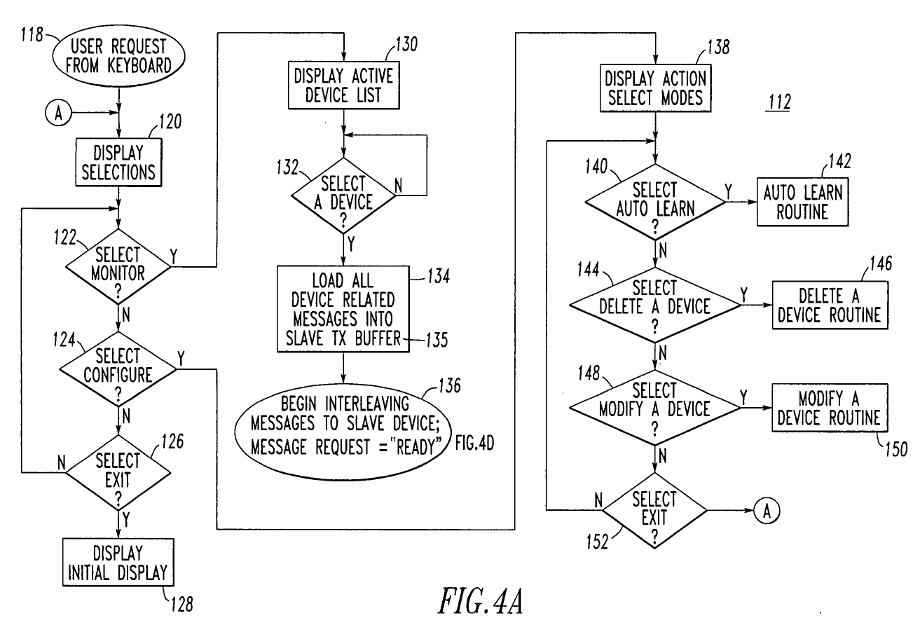

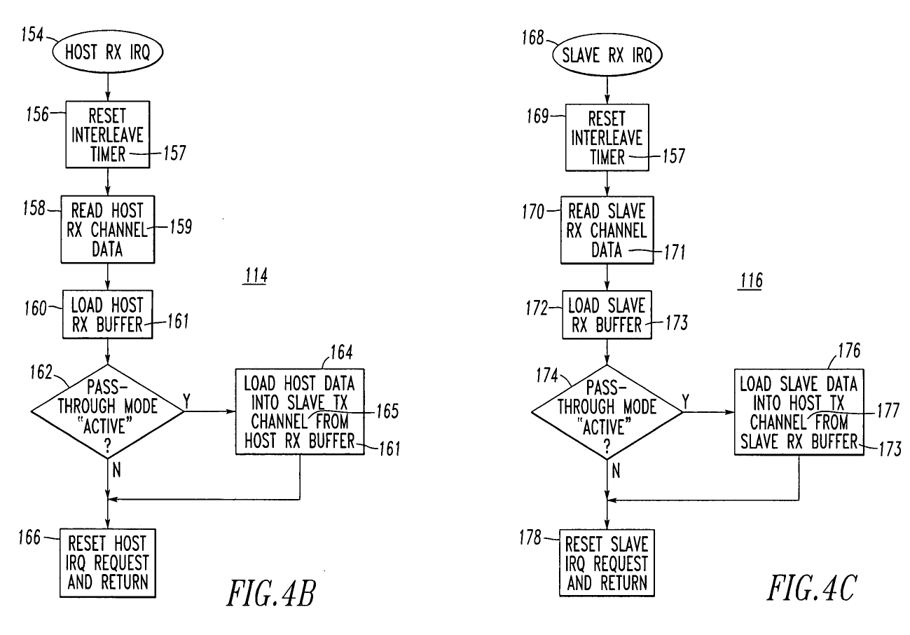

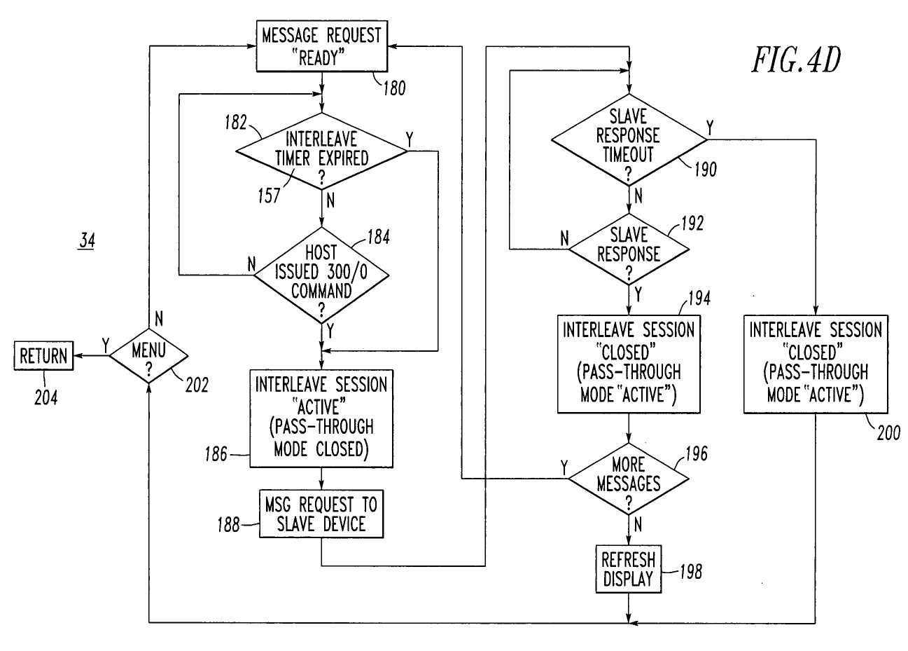

The memory 28 includes a communication routine 34 cooperating with the processor circuit 18. As will be discussed in greater detail, below, in connection with FIG. 4D, the communication routine 34 includes a first mode of operation and a second mode of operation. The first mode of operation receives a first message 36 from the host device 4 to the first communication port 14 and repeats the first message, as message 38, from the second communication port 16 to one of the slave devices 8. The first mode of operation also receives a second message 40 from such one of the slave devices 8 to the second communication port 16 and repeats that second message, as message 42, from the second communication port 14 to the host device 4. In this manner, during the first mode of operation (e.g., pass-through mode), the messages between the host device 4 and the slave devices 8 are communicated as if those devices were on the same communication network.

The second mode of operation of the communication routine 34 interrupts the first mode of operation, sends one or more third messages 44 from the second communication port 16 to one of the slave devices 8, receives one or more fourth messages 46 including information 48 from such one of the slave devices 8 to the second communication port 16, and outputs such information 48, as information 50, to the output device 24. In this manner, during the second mode of operation (e.g., interleave mode), the messages between the display device 12 and the slave devices 8 are interleaved between the messages between the host device 4 and the slave devices 8.

### EXAMPLE 1

The first and second communication ports 14,16 may be INCOM communication ports.

### EXAMPLE 2

The host device 4 may be an INCOM host device. The first communication port 14 may include an INCOM transceiver 52 adapted to communicate with the INCOM host device 4. Here, the interface 22 to the first and second communication ports 14,16 is a dual serial-to-parallel/parallel-to-serial decoder. Alternatively, a separate processor interface (not shown) may be provided for each of the first and second communication ports 14,16.

### EXAMPLE 3

The slave devices 8 may be INCOM slave devices. The second communication network 10 may be an INCOM communication network. The second communication port 16 may include an INCOM transceiver 54 adapted to communicate with the INCOM slave devices 8 on the INCOM communication network 10. The INCOM slave devices 8 have addresses unique to the display device 12 and to the host device 4. For example, the slave addresses may be in the range of 1 through FFH (1 through 255).

### EXAMPLE 4

The slave devices 8 may include a circuit breaker 56, a motor overload relay 58 and a digital meter 60. Alternatively, any suitable electronic device adapted to respond to a suitable host device on a suitable communication network may be employed.

### EXAMPLE 5

Each of the slave devices 8 may include an address 62 (e.g., #1, #2, #3, #n) associated with the second communication port 16. The message 44 may be a request including the address 62 of a corresponding one of the slave devices 8. The message 46 may be a response including the information 48, which, in this example, identifies the type (e.g., type of circuit breaker; type of motor overload relay; type of digital meter) of the corresponding one of the slave devices 8. Also, in this example, the communication routine 34 stores the address and the type of the corresponding one of the slave devices 8 in the processor circuit memory 28.

### EXAMPLE 6

As a refinement of Example 5, as will be discussed below in connection with FIGS. 3E and 4A, a routine 112 may be adapted to send a request from the second communication port 16 to each of the slave devices 8, and to receive a response from each of the slave devices 8 to the second communication port 16, the response defining one of the types for a corresponding one of the slave devices 8.

### EXAMPLE 7

The first messages 36,38 from the host device 4 may include one of a plurality of commands (e.g., as were discussed, above, in connection with Tables 3-5) operatively associated with the slave devices 8. The second messages 40,42 from the corresponding one of the slave devices 8 may include a response to the first messages 36,38.

### EXAMPLE 8

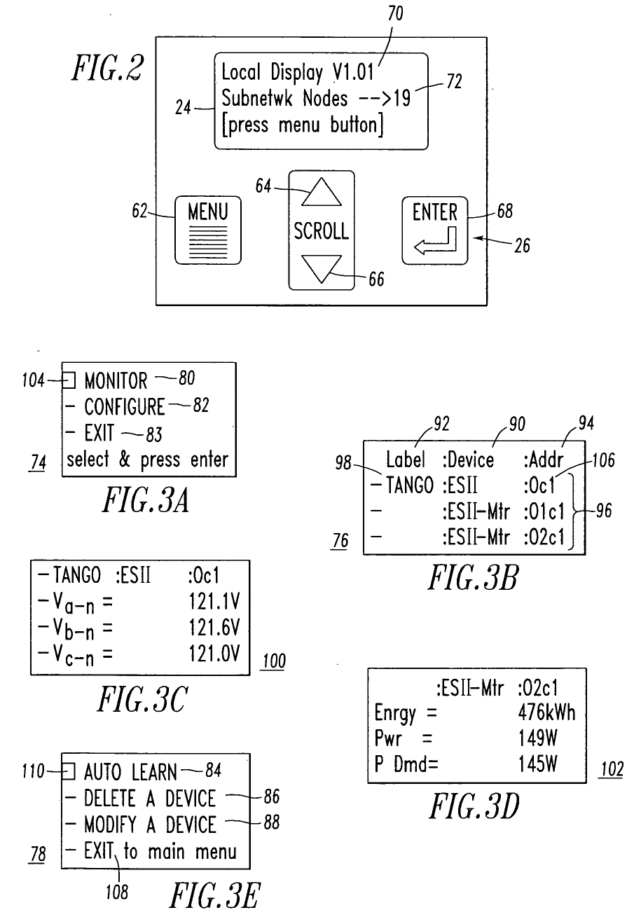

As is shown in FIG. 2, the output device 24 may be a suitable display (e.g., a 20 character by four line LCD display with backlight).

### EXAMPLE 9

As is shown in FIG. 2, the input device 26 may be a suitable keyboard. In this example, the keyboard 26 includes a menu button 62, a scroll up button 64, a scroll down button 66 and an enter button 68.

Continuing to refer to FIG. 2, when the display device 12 of FIG. 1 is first powered on, the display 24 displays information (not shown) identifying that device, its software version number 70 and the count 72 of slave device addresses as stored in the memory 28 (e.g., non-volatile), which addresses are believed to be active on the second communication network 10. When the user presses the menu button 62, the main menu 74 of FIG. 3A is displayed.

The functions of the display device 12 of FIG. 1 are available through the main menu 74 of FIG. 3A. The keyboard buttons 62,64,66,68 of FIG. 2 provide a selection of the menus of FIGS. 3A-3E and various menu options as will be discussed. The menu button 62 permits the user to jump to the main menu 74 at any time during operation. The scroll up and down buttons 64,66 permit the user to scroll through the menus of FIGS. 3A, 3B and 3E and to change slave device addresses as will be discussed. The enter button 68 permits the user to process a selected menu option.

The display device 12 provides views of slave device information from the monitor menu 76 of FIG. 3B, or modifies device related information from the configure menu 78 of FIG. 3E. The menus 76 and 78 are selected from the respective options monitor 80 and configure 82 of the main menu 74 of FIG. 3A. Another option, exit 83, returns the user to the display of FIG. 2. The user presses the scroll up and down buttons 64,66 to move to the desired option selection then presses the enter button 68.

### EXAMPLE 10

Preferably, the configure menu selections 84,86,88 are password-protected. A default password (e.g., 00000) may be saved in the non-volatile memory 28 (FIG. 1) and can be changed by the user from a suitable display screen (not shown).

Referring to FIGS. 3A and 3B, when the user selects monitor 80 from the main menu 74, the monitor menu 76 is displayed as a subsequent screen, in order to display a list of one or more of the slave devices 8 (FIG. 1) based upon the one or more corresponding slave addresses stored within the non-volatile memory 28 (FIG. 1) as a result of the auto learn menu selection 84 (FIG. 3E) as was discussed above in connection with Example 6 and as will be discussed in greater detail, below, in connection with FIG. 3E. In FIG. 3B, the “Device” name 90, device “Label” 92 and device physical address “Addr” 94 information 96 are displayed for each of the one or more of the believed to be active slave devices 8. The user may modify the “Label” 92 information for any of the slave devices 8 using the modify a device selection 88 within the configuration menu 78 of FIG. 3E.

### EXAMPLE 11

As shown in FIG. 3B, three slave devices are shown at addresses 0c1H, 01c1H and 02c1H. Although three addresses are shown, one, two, four or more may be employed, with access being provided by the scroll up and down buttons 64,66 of FIG. 2. The “Device” name 90 column shows the type of slave device (e.g., IQ Energy Sentry II (ESII), IQ Energy Sentry II Meter (ESII-Mtr, ESII-Mtr)) at the respective slave addresses. The first slave device in this list has been configured in the display device 12 (FIG. 1) with the “Label” 92 being a suitable description, such as “TANGO” 98. The user views status information, such as 100 of FIG. 3C or 102 of FIG. 3D, for any of these slave addresses by pressing the scroll up and down buttons 64,66 to move a cursor 104 (as shown in FIG. 3A) to the desired device address and, then, pressing the enter button 68. The type of information then displayed is device-dependent, as identified, for example, below, in connection with Table 6.

For example, in FIG. 3C, the status information 100 (e.g., from an IQ Energy Sentry II) includes Voltage Phase A to Neutral (“Va-n”), Voltage Phase B to Neutral (“Vb-n”) and Voltage Phase C to Neutral (“Vc-n”), while the status information 102 (e.g., from an IQ Energy Sentry II Meter) of FIG. 3D includes Energy (“Enrgy”), Power (“Pwr”) and Power Demand (“P Dmd”). The information displayed is presented in real time from the corresponding slave devices 8.

### EXAMPLE 12

As shown with reference to FIGS. 1, 2 and 3B, the enter key 68 selects one of the slave devices 8 based upon the stored address, such as 106 (“0c1H”). Then, the communication routine 34 sends the one or more third messages 44 including the address 106 from the second communication port 16 to the corresponding one of the slave devices 8. The display 24 displays representations of at least some (e.g., three as shown in FIG. 3B) of the slave devices 8. The enter key 68 selects one of those representations to select the corresponding one of the slave devices 8.

### EXAMPLE 13

In the example of FIG. 3C, the display device 12 sends a 307 command (Table 4) to the corresponding slave device 8 (e.g., an IQ Energy Sentry II), which responds with phase to neutral data.

### EXAMPLE 14

In the example of FIG. 3D, the display device 12 sends a 30F(N=34) command (Table 5) to the corresponding slave device (e.g., an IQ Energy Sentry II Meter), which responds with energy data. The display device 12 then issues a 308 command (Table 4) and the IQ Energy Sentry II Meter responds with power and power demand information.

### EXAMPLE 15

Referring to FIG. 3E, addresses of the slave devices 8 of FIG. 1 can be deleted from the display device memory 28 (FIG. 1) from the configure menu 78, although that action has no effect on the communications between the host device 4 and the slave devices 8. The configure menu 78 is selected from the main menu 74 (FIG. 3A). Prior to displaying the menu 78, a password screen (not shown) may be employed, which requires the user to enter a suitable password. The password is stored in the non-volatile memory 28 and can be changed. After the password is properly entered, the list of FIG. 3E is displayed on the display 24 (FIG. 2). This list includes the functions auto learn 84, delete a device 86, modify a device 88 and exit 108. The user employs the scroll up and down buttons 64,66 to move the cursor 110 to the appropriate function and, then, presses the enter button 68 (FIG. 2). Preferably, a corresponding password screen (not shown) is employed for each of these functions.

After the password is properly entered for the auto learn function 84, a warning screen (not shown) may be displayed. This warning screen alerts the user to the fact that communications between the host device 4 and the slave devices 8 of FIG. 1 will be temporarily halted, thereby giving the user the opportunity to selectively exit to the previous menu or to continue. If the user selects continue (not shown), then an information screen (not shown) is preferably displayed in order to inform the user that the display device 12 is scanning the second communication network 10 (FIG. 1) from address 01H to address FFH to determine if one of the slave devices 8 is present and active at a corresponding address and, if so, to determine the device type thereof. Any such slave addresses and device types are then stored in the non-volatile memory 28 (FIG. 1). After this function is activated, the host device 4 is prohibited from communicating to the slave devices 8 on the second communication network 10 until the process is complete. After this function completes, another information screen (not shown) preferably may indicate the count (e.g., 72 of FIG. 2) of the slave devices 8 now found within the non-volatile memory 28 before redisplaying the configure menu 78 of FIG. 3E.

### EXAMPLE 16

The auto learn function 84 may operate to append addresses of new slave devices 8 to the non-volatile memory 28 of FIG. 1, but does not delete any address from any previously run instance of that function. Hence, addresses of the slave devices 8 are preferably not deleted from the memory 28 by removing one of the slave devices 8 from the second communication network 10 and then re-performing an auto learn session.

### EXAMPLE 17

The delete a device function 86 of FIG. 3E removes from the monitor menu 76 of FIG. 3B a slave device by removing its address from the non-volatile memory 28 of FIG. 1. This function, like the auto learn function 84, is preferably password-protected. After the address of a slave device is deleted, that slave device is not monitored by the display device 12 (FIG. 1) in the interleave mode, but may still be accessed by the host device 4 in the pass-through mode. The delete a device screen (not shown) permits the user to identify the slave device 8 to be deleted by using the device's physical address. The user employs the scroll up and down buttons 64,66 to move a cursor (not shown) to a “Device Addr=00” option (not shown) and then presses the enter button 68 (FIG. 2). The first zero in the address blinks. The user presses the scroll up or down buttons 64,66 to respectively increase or decrease that number. After the user reaches the appropriate first number, the user presses the enter button 68 to select it. In turn, the second number in the address then blinks. The user repeats these steps for selecting the first number to select the second number. At this point, the screen remains the same, except that the cursor blinks in front of a delete (press enter) option (not shown). The user, then, presses the enter button 68 to delete the address of the selected device from the non-volatile memory 28. Alternatively, the user presses the scroll up and down buttons 64,66 to navigate to an exit option (not shown) and, then, presses the enter button 68. In turn, the main menu 74 (FIG. 3A) is shown.

### EXAMPLE 18

The user may return to the previous screen at any time by pressing the menu button 62.

### EXAMPLE 19

The modify a device function 88 applies and changes labels, such as 98 (FIG. 3B), for a slave device. Such entered information is stored in the non-volatile memory 28 and is not associated with labels (not shown) at the host device 4 (FIG. 1). On a modify a device screen (not shown), the user presses the scroll up and down buttons 64,66 to move a cursor (not shown) to a device label (not shown) to be changed and presses the enter button 68 (FIG. 2). In turn, another screen (not shown) is displayed to list the slave device and the description (label) of that device. That label is modified by a process somewhat similar to the selection of the “Device Addr” of Example 17, above. After all of the characters of the label are modified, the screen remains the same, except that the cursor blinks in front of a save option (not shown). The user then presses the enter button 68 to save the selected description for the slave device. In turn, the user presses the scroll up and down buttons 64,66 to advance to an exit option (not shown) and presses the enter button 68. The display device 12 then return to the main menu 74 (FIG. 3A).

FIGS. 4A-4D show routines 112,114,116,34 executed by the processor 20 of FIG. 1. The routine 112 processes the main menu 74 (FIG. 3A), the monitor menu 76 (FIG. 3B) for believed to be active slave devices, and the configure menu 78 (FIG. 3E). The routine 112 starts, at 118, in response to a user request from the keyboard 26 (FIG. 1), such as pressing the menu button 62 in response to the display 24 of FIG. 2. Next, at 120, the different function selections of FIG. 3A are displayed. Steps 122, 124 and 126 respectively determine if the user selected the monitor function 80, the configure function 82 or the exit function 83 of FIG. 3A. If none were selected, then step 122 is repeated. If step 126 determines that the user selected the exit function 83, then, at 128, the initial display of FIG. 2 is displayed.

If step 122 determines that the user selected the monitor function 80, then at 130, the active device list of the monitor menu 76 of FIG. 3B is displayed. Step 132 determines if the user selects a particular one of the slave devices 8 by employing the scroll up and down buttons 64,66 and the enter button 68 of FIG. 2, as was discussed above. If no device was selected, then step 132 is repeated. Otherwise, if one of the slave devices 8 was selected, then, at 134, all of the corresponding slave device related third messages 44 (FIG. 1) are loaded into a slave transmit (Tx) buffer (ST) 135 of the memory 28 (FIG. 1). As was discussed above, the commands for these messages are determined based upon the selected slave device address from FIG. 3B and the corresponding device type (which was learned from the auto learn function 84 of FIG. 3E) from the non-volatile memory 28 of FIG. 1. Then, at 136, those messages 44 are interleaved to the selected slave device by the communication routine 34 of FIG. 4D.

If step 124 determines that the user selected the configure function 82 (FIG. 3A), then at 138, the four action select functions 84,86,88,108 of the configure menu 78 of FIG. 3E are displayed. Steps 140, 144, 148 and 152 respectively determine if the user selected the auto learn function 84, the delete a device function 86, the modify a device function 88 or the exit function 108 of FIG. 3E. If none were selected, then step 140 is repeated. If step 152 determines the user selected the exit function 108, then, at 120, the main menu 74 of FIG. 3A is redisplayed. Otherwise, steps 140, 144 and 148 respectively initiate an auto learn routine 142 (Examples 15 and 16), a delete a device routine 146 (Example 17) and a modify a device routine 150 (Example 19).

Referring to FIG. 4B, the routine 114 is an interrupt service routine responsive to a host receiver interrupt (HOST RX INT) 153 from the decoder 22 of FIG. 1. After starting at 154, the routine 114 resets, at 156, an interleave timer 157 of the processor 20 of FIG. 1, which timer times for a time period (e.g., a suitable time period; about 100 ms). Next, at 158, the data from a host receiver (Rx) channel 159 (HRX) of the decoder 22 is read and, at 160, is loaded into a host receiver (Rx) buffer 161 (HR) in the memory 28. Next, at 162, it is determined if the pass-through mode (FIG. 4D) is active. If so, then, at 164, the host data in HR 161 is loaded into a slave transmitter (Tx) channel 165 (STX) of the decoder 22 for transmission to the corresponding one of the slave devices 8. Finally, after either of steps 162,164, the host receiver interrupt request 153 is reset and the routine 114 returns at 166.

FIG. 4C shows the routine 116, which is an interrupt service routine responsive to a slave receiver interrupt (SLAVE RX INT) 167 from the decoder 22 of FIG. 1. After starting at 168, the routine 116 resets the interleave timer 157 of the processor 20 of FIG. 1, which timer times for the time period of FIG. 4B. Next, the routine 116 reads data from a slave receiver (Rx) channel 171 (SRX) of the decoder 22 and, at 172, loads that data into a slave receiver (Rx) buffer 173 (SR) in the memory 28. Next, at 174, it is determined if the pass-through mode (FIG. 4D) is active. If so, then, at 176, the slave data in SR 173 is loaded into a host transmitter (Tx) channel 177 (HTX) of the decoder 22 for transmission to the host device 4. Finally, after either of steps 174,176, the slave receiver interrupt request 167 is reset and the routine 116 returns at 178.

The host transmit (Tx) buffer (HT) 179 of the memory 28 of FIG. 1 is employed in this example. However, such buffer HT 179 may be employed if the display device 12 were to respond to requests (not shown) from the host device 4.

Referring to FIG. 4D, the communication routine 34 of FIG. 1 is shown. As will be discussed, this routine 34 determines the pass-through mode and the mutually exclusive interleave mode. First, at 180, the appropriate message request is readied from the ST 135 in the memory 28 of FIG. 1. As was discussed above, this may include one of the one or more third messages 44 of FIG. 1. Next, at 182, it is determined if the interleave timer 157 (FIGS. 1 and 4B) has expired. If not, then it is determined, at 184, if the host device 4 issued a “300” command to address “0” by reading the HR 161 of the memory 28 of FIG. 1. Under normal circumstances, the host device 4 issues such a “Transmit Fast-Status” (Table 4) command about every 50-60 ms, in order to reset the slave devices 8 in response to power up or communication error conditions. If such a command was not issued, then step 182 is repeated. On the other hand, if either one of the tests at 182 or 184 is true, then, at 186, the pass-through mode is reset and the interleave mode is set. Then, at 188, the readied message request from step 180 is loaded into the STX channel 165 of the decoder 22 for transmission to the corresponding one of the slave devices 8 of FIG. 1.

Next, at 190, it is determined if the corresponding one of the slave devices 8 did not timely respond to the message sent at step 188. For example, a suitable timer (not shown) (e.g., about 40 ms) is started at 188 and is checked at 190. If the slave device response did not time out, then, at 192, it is determined if there was a response from the corresponding one of the slave devices 8 by checking the corresponding portion of the SR buffer 173 of the memory 28. If there was no slave device response, then step 190 is repeated. On the other hand, if there was a slave response, then, at 194, the interleave mode is reset and the pass-through mode is set. Next, at 196, it is determined if any additional ones of the one or more third messages 44 need to be sent from the ST 135 in the memory 28 of FIG. 1. If so, then step 180 is repeated in order to ready the appropriate next message request from the ST 135. Otherwise, if all of the third messages 44 have been sent and all of the corresponding fourth messages 46 have been received, then the information 48 from those fourth messages 46 is employed to refresh the display 24 of FIG. 1, at 198. For example, this updates the status information, such as 100 of FIG. 3C or 102 of FIG. 3D. Hence, the communication routine 34 outputs the information 48 for all of the fourth messages 46 to the display 24 of FIG. 1 after all of the fourth messages 46 are received from the corresponding one of the slave devices 8.

On the other hand, if there was a slave device response timeout at 190, then, at 200, the interleave mode is reset and the pass-through mode is set. Finally, after either 198 or 200, at 202, it is determined if the menu button 62 of FIG. 2 was depressed. If not, then execution resumes at 180, in order to periodically refresh the display 24 by readying the appropriate next message request from the ST 135. In this manner, the communication routine 34 periodically sends the one or more third messages 44, periodically receives the one or more fourth messages 46, and periodically outputs the information 48 to the display 24 of FIG. 1. If the menu button 62 was pressed, at 202, then the routine 34 returns at 204, in order to display the main menu 74 of FIG. 3A.

### EXAMPLE 20

The interleave mode permits both the host device 4 and the display device 12 on the first communication network 6 to communicate with one or more of the slave devices 8 on the second communication network 10 of FIG. 1. In this example, the display device 12 has two autonomous, INCOM based communication ports 14,16, and the host device 4 and the display device 12 do not share the second communication network 10 simultaneously. The host device 4 and the display device 12 gain access to the second communication network 10 in a prioritized fashion based upon the arbitration algorithm of the communication routine 34 of the display device 12. Normally, the host device 4 has the highest priority on the second communication network 10.

In the pass-through mode of operation, the display device 12 operates as a simple repeater. Messages received from the first communication network 6 are re-transmitted on the second (slave sub-network) communication network 10 without interpretation. Alternately, messages transmitted from a slave device are re-transmitted to the host device 4. This is the default mode of operation for the display device 12.

In the interleave mode of operation, the user may request and view data on the display device 12 from a supported one of the slave devices 8 while operating in unison with the host device 4. The display device 12 accomplishes this by interleaving messages 44,46 between host messages 38 to one of the slave devices 8.

The rules for entering the interleave mode of operation are as follows: (1) the user enters a request for information from the keyboard 26 of the display device 12; (2) the display device 12 monitors activity on the first and second communication ports 14,16; and (3) the display device 12 enters the interleave mode if one of the following conditions is met: (a) 100 ms of dead time is observed on both communications ports 14,16, or (b) the host device 4 issues a “300” command to address “0”. After the display device 12 has entered the interleave mode, this mode will remain in effect until a response is received from the corresponding slave device 8 or a slave device timeout occurs.

An interleave session may include one or more interleaved messages since a request for information may issue one or more corresponding messages. Interleaving is performed on a per message basis until all responsive messages are received from the corresponding slave device 8. Each message first passes the interleaving rules before the interleave mode is entered. This allows the host device 4 to maintain control of the second communication network 10 until it has completed its communications session before the display device 12 gains control of the second communication network 10. This is done to reduce the probability of receiver timeout errors at the host device 4 while it is gathering data from one of the slave devices 8. The display device 12 acquires and displays information from the slave devices 8 (e.g., up to 100) on the second communication network 10 without the need for the host device 4. Information is viewed at the display device 12 while sharing the second communication network 10 with the host device 4. Information acquired by the display device 12 during the interleave mode is not re-transmitted or shared with the host device 4.

Since the display device 12 functions in a transparent fashion, it does not require an operating address and is not directly issued commands from the host device 4. All messages received by the display device 12 on the first communication network 6 are re-transmitted to the slave devices 8 on the second communication network 10 during pass-through mode. Alternately, all messages received on the second communication network 10 are re-transmitted on the first communication network 6 during pass-through mode. Except as was discussed above in connection with step 184 of FIG. 4D, the display device 12 does not interpret commands from the host device 4 in the pass-through mode. The display device 12 defaults to the pass-through mode at power up and may be commanded to operate in the interleave mode by the operator. Mode selection is made from the keyboard 26 and menus are presented to the user from the display 24.

The interleave mode allows the user to view information from one of the slave devices 8 on the second communication network 10 with minimal disruption of host/slave device communications. After the response is received from the corresponding slave device 8, which response satisfies the original request, the display device 12 returns to pass-through mode until the next interleave session. This sequence continues until reset by the operator or by timeout due to operator inactivity. The host device 4 may need to retry following its initial transmission while the display device 12 completes its current transmission sequence.

### EXAMPLE 21

Non-limiting examples of the slave devices 8 of FIG. 1 that are supported by the display device 12 include: (1) IQ 220—four-wire; (2) IQ 230—four-wire; (3) IQ Energy Sentry II—120, 277 and 346 VAC models; (4) IQ Energy Sentinel—F, J, K, UI and UE; (5) IQ Power Sentinel—UE and UI; and (6) Digitrip Optim 550 (K,L,N,REP), 750 (K,L,N,REP) and 1050 (K,L,N,REP). All of these devices are marketed by Eaton Electrical, Inc. of Pittsburgh, Pa.

### EXAMPLE 22

IQ Energy Sentry II devices, for example, are assigned a unique, non-zero address that may be recognized by the display device 12 through the auto learn function 84 (FIG. 3E). After that address is recognized, the display device 12 queries the IQ Energy Sentry II slave device to determine which of its 16 meters (not shown) are active and, in turn, assigns each of such meters a unique address. All active meters within the IQ Energy Sentry II are assigned a unique address by the display device 12. Up to 17 addresses may be assigned to an IQ Energy Sentry II if all 16 of its internal meters are active (e.g., one address for the IQ Energy Sentry II and 16 for its meters).

For example, for the monitor menu 76 of FIG. 3B, the first line on the screen (under Addr) could have an address of * * * 1, such as “00c1”H in FIG. 3B. This represents the physical address as selected on the front panel (not shown) of the IQ Energy Sentry II. Meters enabled within the IQ Energy Sentry II are then listed with addresses starting at 01** (e.g., 01c1H) and ending at 10** (not shown) for a total of up to 16 meters. For example, if the physical address of the IQ Energy Sentry II is 01 and 16 meter points are active therein, then the first meter address will be 01c1H and the last meter address will be 10c1H.

### EXAMPLE 23

Table 6, below, lists example buffers supported by the display device 12 for certain of the slave devices 8.

TABLE 6

| Slave Device | Command | Information |
|---|---|---|
| IQ Energy Sentry II | 300 | Status |
| | 307 | Volts L-N |
| IQ Energy Sentry II Meter | 300 | Status |
| | 308 | Power Buffer #1 |
| | 30F(N = 34) | Energy |
| IQ Energy Sentinel | 300 | Status |
| | 308 | Power Buffer #1 |
| | 30A | Energy |
| IQ Power Sentinel | 300 | Status |
| | 307 | Volts L-N |
| | 30A | Energy |
| | 30F(N = 6) | Power |
| | 30F(N = 7) | Power/Phase |
| IQ 220/230 | 300 | Status |
| | 307 | Volts L-N |
| | 30A | Energy |
| | 30F(N = 6) | Power |
| | 30F(N = 7) | Power/Phase |
| Digitrip Optim | 300 | Status |
| | 308 | Power Buffer #1 |
| | 309 | Power Buffer #2 |
| | 30A | Energy |

While for clarity of disclosure reference has been made herein to the exemplary display 24 for displaying slave device information 50, it will be appreciated that such information may be stored, printed on hard copy, be computer modified, or be combined with other data. All such processing shall be deemed to fall within the terms “display” or “displaying” as employed herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A display device comprising:
a first communication port adapted to communicate with a host device;
a second communication port adapted to communicate with a plurality of slave devices;
a processor circuit including a processor, an interface to said first and second communication ports, an output device and an input device; and
a communication routine cooperating with said processor circuit, said communication routine including a first mode of operation and a second mode of operation, said first mode of operation adapted to receive a first message from said host device to said first communication port and to repeat said first message from said second communication port to a first one of said slave devices, and adapted to receive a second message from said first one of said slave devices to said second communication port and to repeat said second message from said second communication port to said host device, said second mode of operation adapted to interrupt said first mode of operation, to send at least one third message from said second communication port to a second one of said slave devices, to receive at least one fourth message including information from said second one of said slave devices to said second communication port, and to output said information to said output device.

2. The display device of claim 1 wherein said information is selected from the group comprising power, energy, line-to-neutral voltage, and power per phase associated with at least one of said slave devices.

3. The display device of claim 1 wherein said slave devices include a plurality of types; and wherein said communication routine is further adapted to send a request from said second communication port to each of said slave devices, and to receive a response from each of said slave devices to said second communication port, said response defining one of said types for a corresponding one of said slave devices.

4. The display device of claim 3 wherein each of said slave devices includes an address associated with said second communication port; wherein said request includes the address of a corresponding one of said slave devices; wherein said response includes the type of said corresponding one of said slave devices; and wherein said processor circuit further includes a memory storing the address and the type of the corresponding one of said slave devices.

5. The display device of claim 4 wherein said input circuit includes means for selecting one of said slave devices based upon said stored address; and wherein said communication routine is further adapted to send said at least one third message including said address from said second communication port to said second one of said slave devices.

6. The display device of claim 1 wherein said first message includes one of a plurality of commands operatively associated with said slave devices; and wherein said second message includes a response to said first message.

7. The display device of claim 1 wherein said input device includes means for selecting said second one of said slave devices.

8. The display device of claim 7 wherein said communication routine is further adapted to periodically send said at least one third message, to periodically receive said at least one fourth message, and to periodically output said information to said output device.

9. The display device of claim 8 wherein said input device further includes means for terminating periodic sending of said at least one third message, periodic receiving of said at least one fourth message, and periodic outputting of said information.

10. The display device of claim 1 wherein said communication routine is further adapted to determine if no message has been received from said host device to said first communication port for a predetermined time before disabling said first mode of operation and enabling said second mode of operation.

11. The display device of claim 10 wherein said predetermined time is about 100 milliseconds.

12. The display device of claim 1 wherein said communication routine is further adapted to determine if a predetermined message has been received from said host device to said first communication port before disabling said first mode of operation and enabling said second mode of operation.

13. The display device of claim 1 wherein said communication routine is further adapted to disable said second mode of operation and enable said first mode of operation after one of said at least one fourth message has been received from said second one of said slave devices to said second communication port.

14. The display device of claim 1 wherein said communication routine is further adapted to disable said second mode of operation and enable said first mode of operation after no message has been received from said second one of said slave devices to said second communication port after a predetermined time.

15. The display device of claim 14 wherein said predetermined time is about 40 milliseconds.

16. The display device of claim 1 wherein said at least one third message includes a plurality of third messages; wherein said at least one fourth message includes a plurality of fourth messages; and wherein said communication routine is further adapted to disable said first mode of operation and enable said second mode of operation before sending one of said third messages from said second communication port to said second one of said slave devices and to disable said second mode of operation and enable said first mode of operation after one of said fourth messages has been received from said second one of said slave devices to said second communication port.

17. The display device of claim 16 wherein said communication routine is further adapted to output said information for all of said fourth messages to said output device after all of said fourth messages are received from said second one of said slave devices to said second communication port.

18. The display device of claim 1 wherein said output device includes means for displaying representations of at least some of said slave devices; and wherein said input device includes means for selecting one of said representations to select said second one of said slave devices.

19. A display system comprising:
a host device;
a first communication network;
a plurality of slave devices;
a second communication network; and
a display device comprising:
a first communication port communicating with said host device over said first communication network,
a second communication port communicating with said slave devices over said second communication network,
a processor circuit including a processor, an interface to said first and second communication ports, an output device and an input device, and
a communication routine cooperating with said processor circuit, said communication routine including a first mode of operation and a second mode of operation, said first mode of operation receiving a first message from said host device to said first communication port and repeating said first message from said second communication port to a first one of said slave devices, and receiving a second message from said first one of said slave devices to said second communication port and repeating said second message from said second communication port to said host device, said second mode of operation interrupting said first mode of operation, sending at least one third message from said second communication port to a second one of said slave devices, receiving at least one fourth message including information from said second one of said slave devices to said second communication port, and outputting said information to said output device.

20. The display system of claim 19 wherein said first and second communication ports are INCOM communication ports.

21. The display system of claim 19 wherein said host device is an INCOM host device; and wherein said first communication port includes an INCOM transceiver adapted to communicate with said INCOM host device.

22. The display system of claim 19 wherein said slave devices are INCOM slave devices; wherein said second communication network is an INCOM communication network; and wherein said second communication port includes an INCOM transceiver adapted to communicate with said INCOM slave devices on said INCOM communication network.

23. The display system of claim 19 wherein said slave devices are selected from the group comprising a circuit breaker, a motor overload relay and a digital meter.
